(19) United States
(12) Patent Application Publication
(10) Pub. No.: US 2007/0223874 A1
(43) Pub. Date: Sep. 27, 2007

(54) Video-Audio Synchronization

(75) Inventor: Christian Hentschel, Cottbus (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,607

(22) PCT Filed: Mar. 29, 2005
(86) PCT No.: PCT/IB05/51061

§ 371 Date: Oct. 3, 2006

(30) Foreign Application Priority Data
Apr. 7, 2004 (EP) 04101436.6

(51) Int. Cl. H04N 7/52

(52) U.S. Cl. 386/89; 348/E05.009

(57) ABSTRACT

Visual and aural output from an audiovisual system (100, 200, 300) are synchronized by a feedback process. Visual events and aural events are identified in an audio signal path and a video signal path, respectively. A correlation procedure then calculates a time difference between the signals and either the video signal or the audio signal is delayed in order to obtain a synchronous reception of audio and video by a viewer/listener.

The present invention relates to a method and a system for synchronizing audio output and video output in an audiovisual system.

In present audiovisual systems the flow of information between different devices are increasingly in the form of data streams representing sequences of visual data, i.e. video data, and sound, i.e. audio data. Usually digital data streams are transmitted between devices in an encoded form, e.g. MPEG, and hence there is a need for powerful digital data encoders and decoders. These encoders and decoders, although powerful enough to provide satisfactory performance in an absolute sense, there are problems relating to differences in performance between devices and, in particular, differences in performance when considering video data versus audio data. In short, there are problems relating to synchronization of sound and picture from the point of view of a person viewing, e.g., a film using a DVD-player connected to a television unit. Very often, the video signal is delayed with respect to the audio signal, thus calling for a delaying function acting on the audio signal. In addition, typically video processing for or in a display device uses frame memories causing additional delays for the video signal. The delay may vary depending on the input source and content (analogue, digital, resolution, format, input signal artifacts, etc.), selected video processing for this specific input signal, and resources available for video processing in a scalable or adaptive system. In particular, there is typically no way of predicting the extent of a synchronization problem when a system comprising a number of different devices, possibly from different manufacturers, are used.

A prior art example of a synchronization arrangement is disclosed in published UK patent application GB2366110A. Synchronization errors are in GB2366110A eliminated by way of using visual and audio speech recognition. However, GB2366110A does not discuss a problem relating to a situation where a complete chain of functions, i.e. from a source such as a DVD-player to an output device such as a TV-set, is considered. For example, GB2366110A does not disclose a situation where a delay is introduced by video data processing close to the actual display, such is the case in a high-end TV-set or graphics card in a PC.

It is hence an object of the present invention to overcome drawbacks related to prior art systems as discussed above.

In an inventive system synchronization of audio output and video output is obtained via a number of steps. An audio signal and a video signal are received and provided to a loudspeaker and a display, respectively. The audio signal is analyzed, including identifying at least one aural event and the video signal is also analyzed, including identifying at least one visual event. The aural event is associated with the visual event, during which association a time difference between the aural event and the visual event is calculated. A delay is then applied on at least one of the audio signal and the video signal, the value of which delay being dependent on the calculated time difference between the aural event and the visual event. The audio output and the video output are thereby synchronized.

Preferably, the analysis of the video signal is performed subsequent to any video processing of the signal (at least that digital video processing which introduces considerable delay), and the analysis of the audio signal is performed subsequent to the audio signal being emitted by the loudspeaker and received via a microphone, preferably located in the vicinity of the system and the viewer.

It is rather easy to measure the sound emitted by a loudspeaker of the display system by means of a microphone in the room, and the pick-up time of the sound by the microphone is comparable to the time of entering the viewer's ear (hence the delay compensation is tuned to what the viewer perceives), and of emission by the loudspeaker, at least on a time-scale of typical audio/video delays (typically of the order of a tent of a second or less).

Placing a camera as an equivalent to the microphone is rather cumbersome, and there may be additional camera-related delays.

The insight of the inventor is that the video signal can be timed right before it is being displayed by the display, at such a point that the further delay is also negligible given the system's required precision (the required accuracy for lip-sync is well-known from psycho-acoustic experiments).

The analysis of the audio signal and the video signal are hence preferably performed late in a processing chain, i.e. near the point in the system where the audio signal and the video signal is converted to mechanical sound waves and optical emission from a display screen (e.g. before going into the drivers of an LCD screen, to the cathodes of a CRT etc.). This is advantageous since it is then possible to obtain very good synchronization of sound and view as perceived by a person viewing the output. Particularly advantageous is the invention when utilized in a system where a large amount of video signal processing is performed prior to the video signal being emitted via display hardware, which is the case for digital transmission systems where encoded media must be decoded before being displayed. Preferably, the invention is realized in a TV-set comprising the analysis functions and delay correction.

Note that the processing may also be done in another device (e.g. a disk reader, provided that some information about the delays further in the chain—such as video processing in high-end TV set—is communicated—e.g. a wired/wireless communication of measured signals or timing information with respect to a master clock—to this disk reader). Communicating delays and/or measuring at appropriate points in the chain—in particular near the viewer experience—makes it possible to compensate for delays of apparatuses in the television system to which no internal access is possible.

Since the delay correction is performed in the signal processing chain prior to the audio measure late in the chain, the delay correction is done via a regulation feedback loop.

In an embodiment of the invention the audio signal and the video signal comprises a test signal having substantially simultaneous visual and aural events. The test signal is preferably of rather simple structure for easy identification and accurate measurement of the delays.

The value of the delay is in a preferred embodiment stored and in a further embodiment identification information is received regarding a source of the audio signal and the video signal. The stored delay value is then associated with the information regarding the source of the audio and video signal. An advantage of such a system is hence that it is thereby capable of handling a number of different input devices in an audiovisual system, such as a DVD player, a cable television source or a satellite receiver.

By performing the synchronization steps, as discussed above, in a continuous manner it is possible to obtain synchronization of video and audio signals from sources that are marred by changing difference in delay value. This includes exchange of devices and processing paths.

E.g. a compression standard may be received with varying complexity depending on the scene content resulting in variable delays, or the processing may be content dependent (e.g. motion based upconversion of a motion picture running in the background is changed to a computationally simpler variant when an email message pops up).

The invention will now be described with reference to the drawings on which:

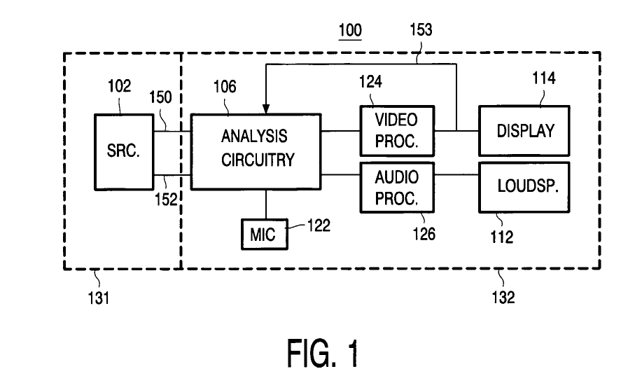

FIG. 1 shows schematically a block diagram of an audiovisual system in which the present invention is implemented.

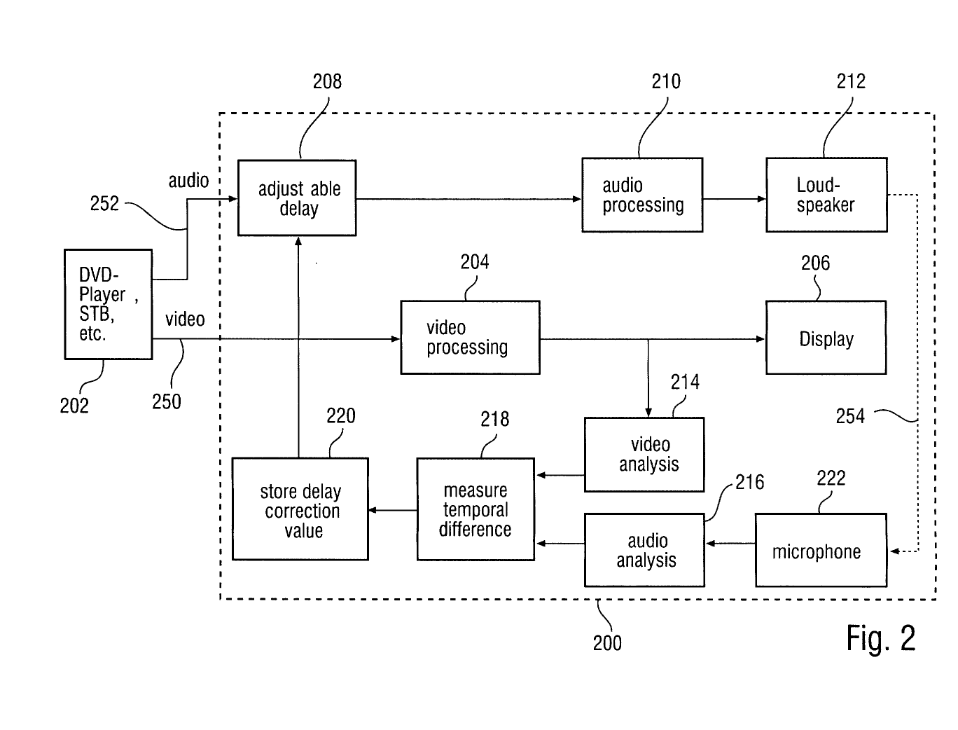

FIG. 2 shows schematically a functional block diagram of a first preferred embodiment of a synchronization system according to the present invention.

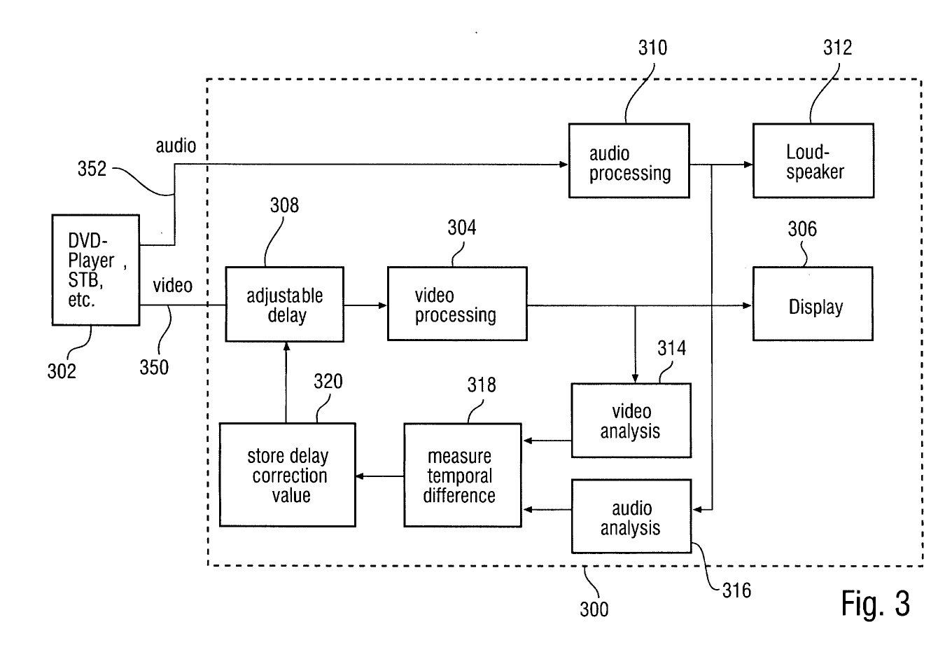

FIG. 3 shows schematically a functional block diagram of a second preferred embodiment of a synchronization system according to the present invention.

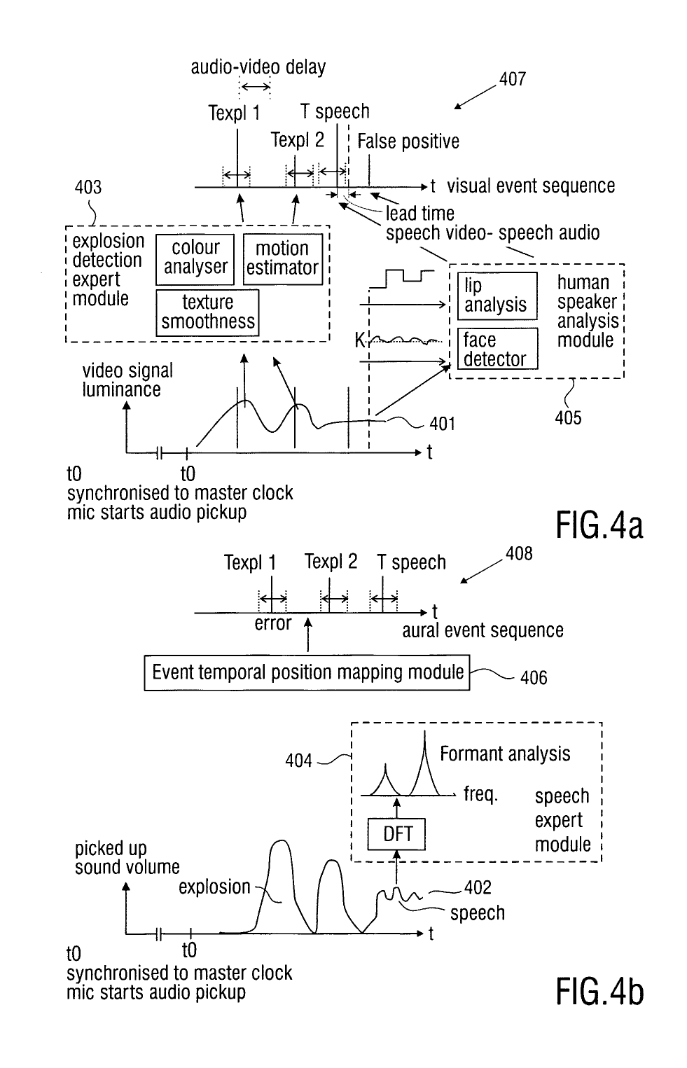

FIGS. 4a and 4b schematically illustrate video signal analysis and audio signal analysis, respectively.

FIG. 1 shows an audiovisual system 100 comprising a TV-set 132, which is configured to receive video signals 150 and audio signals 152, and a source part 131 providing the video and audio signals 150, 152. The source part 131 comprises a media source 102, e.g. a DVD-source or a cable-TV signal source etc., which is capable of providing data streams comprising the video signal 150 and the audio signal 152.

The TV-set 132 comprises analysis circuitry 106 capable of analyzing video signals and audio signals, which may include such sub-parts as input-output interfaces, processing units and memory circuits, as the skilled person will realize. The analysis circuitry analyses the video signal 150 and the audio signal 152 and provides these signals to video processing circuitry 124 and audio processing circuitry 126 in the TV-set 132. A microphone 122, including any necessary circuitry to convert analogue sound into a digital form, is also connected to the analysis circuitry 106.

The video processing circuitry 124 and the audio processing circuitry 126 of the TV-set 132 prepares and presents visual data and sound on a display 114 and in a loudspeaker 112, respectively. Typically, the processing delays occur because of decoding (re-ordering of pictures), picture interpolation for frame-rate upconversion, etc.

A feedback line 153 provides the video signal, after being processed in the video processing circuitry 124, to the analysis circuitry 106, as will be discussed further in connection with FIGS. 2 to 4. Instead of being in the direct path the analysis can also be done in a parallel branch etc.

The source part 131 may in alternative embodiments comprise one or more of the units residing in the TV-set 132, such as the analysis circuitry 106. For example, a DVD-player may be equipped with analysis circuitry, thereby making it possible to use an already existing TV-set and still benefiting from the present invention.

As the skilled person will realize, the system in FIG. 1 typically comprises a number of additional units, such as power supplies, amplifiers and many other digital as well as analogue units. Nevertheless, for the sake of clarity only those units that are relevant to the present invention is shown in FIG. 1. Moreover, as the skilled person will realize, the different units of the system 100 may be implemented in one or more physical components, depending on the level of integration.

The operation of the invention using, e.g., the different units of the system 100 in FIG. 1 will now be described further with reference to functional block diagrams in FIGS. 2 and 3.

In FIG. 2 a synchronization system 200 according to the present invention is schematically shown in terms of functional blocks. A source unit 202, such a DVD-player or set-top box of a cable-TV network etc., provides a video signal 250 and an audio signal 252 to the system 200. The video and audio signals 250,252 may be provided via a digital data stream or via an analogue data stream, as the skilled person will realize.

The video signal 250 is processed in video processing means 204 and presented to a viewer/listener in the form of a picture on a display 206. The audio signal 252 is processed in audio processing means 210 and output to a viewer/listener in the form of sound via a loudspeaker 212. Both the video processing and the audio processing may involve analogue/digital and digital/analogue conversion as well as decoding operations. The audio signal is subject to an adjustable delay processing 208, the operation of which is depending on an analysis of a temporal difference, as will be explained below.

The video signal is, after being video processed 204 and immediately before (or simultaneous with) being provided to the display 206, subject to video analysis 214. During video analysis the sequence of images comprised in the video signal are analyzed and searched for particular visual events such as shot changes, start of lip movement by a depicted person, sudden content changes (e.g. explosions) etc., as will be discussed further below in connection with FIG. 4a.

Together with the video analysis, audio analysis is performed on the audio signal received via a microphone 222 from the loudspeaker 212. The microphone is preferably located in close proximity of a viewer/listener. During the audio analysis, the audio signal is analyzed and searched for particular aural events such as sound gaps and sound starts, major amplitude changes, specific audio content events (e.g. explosions) etc., as will be discussed further below in connection with FIG. 4b.

In an alternative embodiment, the visual events and aural events may be part of a test signal provided by the source unit. Such a test signal may comprise very simple visual events, such as one frame containing only white information among a number of frames containing only black information, and simple aural events such as an very short audio snippet (e.g. short tone, burst, click, . . . ).

The results, in the form of detected visual and aural events, of the video analysis 214 and the audio analysis 216 respectively, are both provided to a temporal difference analysis function 218. Using, e.g., correlation algorithms associations are made between visual and aural events and time differences between these are calculated, evaluated, and stored by a storage function 220. The evaluation is important to ignore weak analysis results and to trust events with high probability of video and audio correlation. After some regulation time, the temporal differences become close to zero. This also helps in identifying weak audio and video events. After switching to a different input source, the delay value may change. The switch to the new input source and optionally its properties may be signaled to one or more of the video-audio correlation units 214, 216, 218 and 220. In this case, a stored delay value for the new input source can be selected for immediate delay compensation.

The stored time differences are then used by the adjustable delay processing 208, resulting in a recursive convergence of the time differences in the difference analysis function 218 and thereby obtaining synchronization of audio and video as perceived by a viewer/listener.

As an alternative, the adjustable delay processing 208 of the audio signal may reside in the source unit 202, or later in the audio processing chain (e.g. between different stages of an amplifier).

Turning now to FIG. 3, another embodiment of a synchronization system 300 according to the present invention is schematically shown in terms of functional blocks. A source unit 302, such a DVD-player or set-top box of a cable-TV network etc., provides a video signal 350 and an audio signal 352 to the system 300. As in the previous embodiment, the video and audio signals 350,352 may be provided via a digital data stream or via an analogue data stream.

The video signal 350 is processed in video processing means 304 and presented to a viewer/listener in the form of a picture on a display 306. The audio signal 352 is processed in audio processing means 310 and output to a viewer/listener in the form of sound via a loudspeaker 312. Both the video processing and the audio processing may involve analogue/digital and digital/analogue conversion as well as decoding operations. The video signal is subject to an adjustable delay processing 308, the operation of which is depending on an analysis of a temporal difference, as will be explained below.

The video signal is, after being processed 304 and immediately before (or simultaneous with) being provided to the display 306, subject to video analysis 314. During video analysis the sequence of images comprised in the video signal are analyzed and searched for particular visual events such as shot changes, start of lip movement by a depicted person, sudden content changes (e.g. explosions) etc., as will be discussed further below in connection with FIG. 4a.

Simultaneous with the video analysis, audio analysis 316 is performed on the audio signal. In contrast to the embodiment described above, where an audio signal is received via a microphone 222 from the loudspeaker 212, here the audio signal is directly, i.e. simultaneous with being output via the loudspeaker 312, provided to the audio analysis 316 function. During the audio analysis 316, the audio signal is analyzed and searched for particular aural events such as sound gaps and sound starts, major amplitude changes, specific audio content events (e.g. explosions) etc., as will be discussed further below in connection with FIG. 4b.

As above, in an alternative embodiment the visual events and aural events may be part of a test signal provided by the source unit 302.

The results, in the form of detected visual and aural events, of the video analysis 314 and the audio analysis 316 respectively, are both provided to a temporal difference analysis function 318. Using, e.g., correlation algorithms associations are made between visual and aural events and time differences between these are calculated, evaluated, and stored in a storage function 320. The evaluation is important to ignore weak analysis results and to trust events with high probability of video and audio correlation. After some regulation time, the temporal differences become close to zero. This also helps in identifying weak audio and video events. After switching to a different input source, the delay value may change. The switch to the new input source and optionally its properties may be signaled to one or more of the video-audio correlation units 314, 316, 318 and 320. In this case, a stored delay value for the new input source can be selected for immediate delay compensation.

The stored time differences are then used by the adjustable delay processing 308, resulting in a recursive convergence of the time differences in the difference analysis function 318 and thereby obtaining synchronization of audio and video as perceived by a viewer/listener.

As in the previous embodiment, the adjustable delay processing 308 of the video signal may alternatively reside in the source unit 302, or later in the audio processing chain (e.g. between pre- and main amplifier).

Turning now to FIGS. 4a and 4b, an embodiment of analysis of visual events and aural events, as well as association of these for the purpose of obtaining delay values, will be discussed in some more detail.

In FIG. 4a, video signal luminance 401 as detected immediately prior to being provided to display output hardware in a CRT or LCD etc., as a function of time, is analyzed in the example two different video expert modules: an explosion detection expert module 403 and a human speaker analysis module 405. The output of these modules is a visual event sequence 407, being e.g. typically coded as a sequence of time instants (Texpl1 the estimated time instant of a first detected explosion, etc.).

Correspondingly, in FIG. 4b sound volume signal 402 as a function of time is analyzed in one or more audio detection expert modules 404, to obtain the timings related to the same master clock starting time instant (t0), the events being shifted to the future due to an audio-visual delay. The example audio detection expert module 404 comprises components such as a discrete Fourier transform module (DFT) and a formant analysis module (for detecting and modeling a speech part), the output of which is provided to an event temporal position mapping module 406, used in this example to associate temporal locations with the analyzed subpart aural waveforms. I.e. the output of the temporal position mapping module 406 is an aural event sequence 408 (the mapping may alternatively happen in the expert modules themselves as in the video examples).

These modules, i.e. the video and audio expert modules 405,404, (mapping module 406) typically do the following: identification of whether a snippet is of a particular type, identifying its temporal extent and then associating a time instance (e.g. a heuristic may define the point of onset of speech).

E.g., a video expert module capable of recognizing explosions also calculates a number of extra data elements: a color analyzer recognizes in an explosion that a large part of an image frame is whitish, reddish or yellowish, which shows up in a color histogram of successive pictures. A motion analyzer recognizes a lot of variability between a relatively still scenery before an explosion and fast changes of explosion. A texture analyzer recognizes that an explosion is rather smooth in terms of texture over an image frame. Based on a particular output of all these measurements a scene is classified as an explosion.

Facial behavior modules can also be found in the literature by the skilled person, e.g. lips can according to prior art be tracked with so-called snakes (mathematical boundary curves). Different algorithms may be combined to yield expert modules of different required accuracy and robustness.

With heuristic algorithms these measurements are typically converted in a confidence level [0,1], that is e.g. all pictures above a threshold k=+/−1 are identified as explosions.

The audio expert module for recognizing explosion checks things like volume (increase), deep basses, and surround channel distribution (explosions are often in the LFE (low frequency effects) channel).

Association between visual events and audio events is then, in principle, straightforward: a peak in the audio corresponds to a peak in the video.

However, the situation may be more complex. That is, the heuristics of mapping to a specific time instance (e.g. onset of speech sequence) may introduce an error (a different heuristic will put the time instant somewhere else), the calculation of the evidences may introduce an error, there may be an in-video lead time between audio and video (e.g. resulting from the editing of the source signals the audio event is positioned a short time after a corresponding video event), the are false positives (i.e. too many events) and false negatives (i.e. missing events). Hence, single mapping of one visual event onto one aural event may not work very well.

Another way in which to associate visual events and aural events is to map a number of events, i.e. a scene signature. For example, using a typical formula, audio and video events match if they occur on their timeline within: T_{A}=T_{V}+D+/−E, where T_{A} and T_{V} are the exact event time instants provided by the expert modules, D is the currently predicted delay and E is an error margin.

The number of matches is a measure of how accurate the delay is estimated, i.e. the maximum match (number) obtained over all possible delays yields a good estimate of the actual delay. Of course, the events have to be of the same type. For example, an explosion should never be matched with speaking, even if their time instants differ by almost the exact delay, since this clearly would be an error.

This is already good for matching, but E should not be too large, otherwise there is a remaining maximal error of E with an average E/2.

Since by addition Gaussian errors may average out somewhat, it is possible to estimate matches more accurately. Based on ranking analysis, e.g. if there are two consecutive explosions it is most likely that the first audio explosion event should be matched with the first video event and so for the second etc. These ranking-based matches are then differentiated yielding a set of delays: D1=T_{A1}−T_{V1}, (explosion 1), D2=T_{A2}−T_{V2} (explosion 2), etc. These are then summed for consecutive events, yielding a more stable average delay estimate.

In practice, instead of loading segments of audio and video into the expert modules, the video and audio signals can be processed “on-the fly” and then long enough segments of annotated (i.e. which type of explosion, speech etc.) event time sequences may be matched. There may be delayed analysis if the delays stay the same for rather long periods and/or a short delay mismatch is tolerable.

Hence, to summarize, visual and aural output from an audiovisual system are synchronized by a feedback process. Visual events and aural events are identified in an audio signal path and a video signal path, respectively. A correlation procedure then calculates a time difference between the signals and either the video signal or the audio signal is delayed in order to obtain a synchronous reception of audio and video by a viewer/listener.

The algorithmic components disclosed may in practice be (entirely or in part) realized as hardware (e.g. parts of an application specific IC) or as software running on a special digital signal processor, a generic processor, etc.

Under computer program product should be understood any physical realization of a collection of commands enabling a processor—generic or special purpose—, after a series of loading steps to get the commands into the processor, to execute any of the characteristic functions of an invention. In particular the computer program product may be realized as data on a carrier such as e.g. a disk or tape, data present in a memory, data traveling over a network connection—wired or wireless—, or program code on paper. Apart from program code, characteristic data required for the program may also be embodied as a computer program product.

It should be noted that the above-mentioned embodiments illustrate rather than limit the invention. Apart from combinations of elements of the invention as combined in the claims, other combinations of the elements are possible. Any combination of elements can be realized in a single dedicated element.

Any reference sign between parentheses in the claim is not intended for limiting the claim. The word “comprising” does not exclude the presence of elements or aspects not listed in a claim. The word “a” or “an” preceding an element does not exclude the presence of a plurality of such elements.

1. A method of synchronizing audio output and video output in an audiovisual system (100, 200, 300), comprising the steps of:
receiving an audio signal and a video signal,
providing the audio signal to a loudspeaker (112, 212, 312),
analyzing the audio signal, including identifying at least one aural event from the audio signal,
providing the video signal to a display unit (114, 206, 306),
analyzing the video signal, including identifying at least one visual event from the video signal,
associating the aural event with the visual event, including calculating a time difference between the aural event and the visual event,
applying a delay on at least one of the audio signal and the video signal, the value of which delay being dependent on the calculated time difference between the aural event and the visual event, thereby synchronizing the audio output and the video output.

2. The method of claim 1, in which the step of analyzing the video signal is performed subsequent to any video processing of the signal.

3. The method according to claim 1, in which the step of analyzing the audio signal is performed subsequent to the audio signal being emitted by the loudspeaker and received via a microphone (122, 222).

4. The method according to claim 1, in which the audio signal and the video signal comprise a test signal having substantially simultaneous visual and aural events.

5. The method according to claim 1, further comprising the step of storing the value of the delay.

6. The method according to claim 5, wherein stored delay values are associated with information regarding a respective source of the audio and video signal.

7. The method according to claim 6, further comprising the steps of:
receiving identification information regarding a source of the audio signal and the video signal, and
associating the delay value with the information regarding the source of the audio and video signal.

8. The method according to claim 1, wherein the steps of:
receiving an audio signal and a video signal,
providing the audio signal to a loudspeaker,
analyzing the audio signal, including identifying at least one aural event from the audio signal,
providing the video signal to a display unit,
analyzing the video signal, including identifying at least one visual event from the video signal,
associating the aural event with the visual event, including calculating a time difference between the aural event and the visual event, and
applying a delay on at least one of the audio signal and the video signal, the value of which delay being dependent on the calculated time difference between the aural event and the visual event, are continuously repeated and thereby providing a dynamic synchronization of the audio output and the video output.

9. A system (131) for synchronizing audio output and video output in an audiovisual system (100, 200, 300), comprising:
means (106) for analyzing signals from a signal source (102), including identifying at least one aural event from an audio part of the signals from the signal source and identifying at least one visual event from a video part of the signals from the signal source,
means (106) for associating the aural event with the visual event, including calculating a time difference between the aural event and the visual event,
means (106) for applying a delay on one of the audio signal and the video signal, the value of which delay being dependent on the calculated time difference between the aural event and the visual event, thereby synchronizing the audio output and the video output, and
means (124, 126) for providing the audio signal and the video signal to a loudspeaker (112, 222, 322) and a display (114, 206, 306), respectively.

10. The system according to claim 9, in which means for analyzing the video signal are located subsequent to any means for processing the video signal.

11. The system according to claim 9, in which means for analyzing the audio signal is configured to receive the audio signal via a microphone (122).

12. The system according to claim 9, further comprising means (108) for storing the value of the delay.

13. The system according to claim 12, further comprising:
means for receiving identification information regarding a source of the audio signal and the video signal, and
means for associating the delay value with the information regarding the source of the audio and video signal.

14. A computer program product comprising code to enable a processor to execute the method of claim 1.
